(19) United States
(12) Patent Application Publication
(10) Pub. No.: US 2016/0325202 A1
(43) Pub. Date: Nov. 10, 2016

(54) Waste Water Evaporation System

(71) Applicants: John Christopher Phillips, Coeur d'Alene, ID (US); Eric Christopher Devereaux, Coeur d'Alene, ID (US)

(72) Inventors: John Christopher Phillips, Coeur d'Alene, ID (US); Eric Christopher Devereaux, Coeur d'Alene, ID (US)

(21) Appl. No.: 14/703,898

(22) Filed: May 5, 2015

(51) Int. Cl. B01D 1/20; C02F 1/04

(52) U.S. Cl. CPC B01D 1/20; C02F 1/048

(57) ABSTRACT

This invention generally relates to a method of waste water evaporation and a waste water evaporator. A waste water evaporation system having a waste water reservoir which receives waste water from a waste water source. Equipped with recirculation pumps to deliver waste water to at least one nozzle through a network of pipe which discharges atomized waste water by hydraulic pressures though an orifice in nozzle(s) sized properly to finely atomize waste water into the atmosphere. Any waste water not reduced in volume by evaporation into the atmosphere or by contact with the solar heated non permeable liner returns to the waste water containment vessel to begin the process over.

### BACKGROUND OF THE INVENTION

Industrial waste water is becoming increasingly difficult to manage and handle due to the tightening rules and regulations by the local governing authorities. As discharge requirements tighten, many companies and municipalities are turning to other methods to treat and handle their waste water. Environmental regulators are requiring cleaner and cleaner effluent to meet and application and discharge guidelines.
Many municipalities or companies that produce waste water have relied on publicly owned treatment works (POTW)(Waste Water Treatment Plants) to dispose of their waste water. The costs of trucking and disposal fees are costly and time consuming. Land application of waste water is a long process which may take years to obtain permitting, and require large tracts of and to do so specific soil types must be met as well to even attempt to and apply waste water. A common disadvantage to traditional evaporation systems is contamination of the surrounding areas outside of the intended footprint of the evaporaton area by overspray. The risk of contamination of wildlife, vegetation, streams, rivers, creeks, groundwater control, or generally the environment is a real concern. This inventive method over like systems or processes is the lack of overspray. The low impact of this system reduces these risks by way of a low canopy of moisture produced by the evaporation system. It is able to be better contained within a designated footprint. Evaporation requires very little maintenance cost to start and run.
Solids are retained in the footprint of ponds, sumps, tanks, etc.
Zero discharge to fresh water.
Exponentially decreases volume of waste water down to slurry, sludge, or manageable solids that can be disposed of in solid waste facilities.

Depending on concentration of waste water, it is not uncommon to reduce he quantity of liquid by 98 to 99 percent.

Advancement.
Waste water is typically consolidated or collected or stored in a lined or unlined pit(s), tank(s), storage vessel(s), or other similar or like adequate containment.
The liquid waste water is pumped via one or more pumps equipped with inlet and outlet screens through a network of pipe.
This piping has been found to work most efficient when it is manufactured or built out of high density of polyethylene (HDPE).
These pumps can be powered electrically which can be run, driven, or controlled by a variable frequency drive (VFD). This is the preferred method but not necessary.
The inlet screen consisting of a one way water valve, foot valve, or like check valve to maintain the prime on the pumps when not in operation. On the outlet side of the pump(s) an in line screen is preferred to prevent any solids introduced into the pump(s) suction from plugging or restricting the spray heads or nozzles.
Optional ball, gate or other like valves used on the outlet side of the pump(s) for incremental restriction of fluid flow. The purpose of regulation of pressures and volumes to the spray heads or nozzles is to lower the risk of overspray due to unfavorable wind conditions.
Spray heads fastened to said pipe in a grid formation or pattern as the spray from the nozzles does not overlap spray, mist, or pattern of another nozzle or spray head discharge. The best results were obtained using this manner or fashion.
Said grid structure or pattern can be constructed in such a manner to obtain floatation in pond(s), tank(s), or any containment vessel(s).
Waste water is atomized as it is leaving or being discharged from the outer most point of the system (a nozzle or spray head). Spray, mist, or pattern heights vary based on pressures and volumes. This also affects efficiency of evaporation.
Risers placed on the pipe to elevate the spray head or nozzle into the air will increase efficiency. This increases the time the water droplets are in contact with the air. Thus increasing evaporation.
Waste water return from liquid from spray head or nozzle discharge is captured via a water proof/impermeable liner. Dark in color is preferred. This increases evaporation rates of un-evaporated atomized liquid droplets that return to the liner which is naturally solar heated.
The sub grade of said evaporation area will be sloped to direct and return the un-evaporated liquid or wastewater to the lined or unlined pit(s), tank(s), storage vessel(s), and other similar or like adequate containment at which point would be re-circulated through the system.
Elevated side slopes or adequate wind fences can be utilized to contain over spray.

Elevated side slopes are preferred. The sloping characteristics return un-evaporated liquid to the lined or unlined pit(s), tank(s), storage vessel(s), and other similar or like adequate containment. The sloped sidewalls also act as a point for the un-evaporated liquid droplets to evaporate from the liner which is normally naturally solar heated. (This system uses 12 to 14 vertical foot walls sloped at an average of 2:1 comprised of day soil covered in a water proof/impermeable liner.)

### ENVIRONMENTAL SAFETY MECHANISMS AND CONTROLS These are optional based on environmental regulations or environmental concerns.

### OVERSPRAY CONTROL

Optional ball, gate or other like valves used on the outlet side of the pump(s) for Incremental restriction of fluid flow. The purpose of regulation of pressures and volumes to the spray heads or nozzles is to lower the risk of overspray due to unfavorable wind conditions.
Weather station(s) or other types of process control can be utilized for automation. This allows automated shut down of mister, nozzles, or spray head zones to be turned off as well as pump(s) able to be controlled if winds became too high preventing overspray from the evaporation field or outside of the foot print of desired waste water containment area(s).
The weather station can also be utilized to detect relative humidity, temperature, and wind direction, which are all factors that can be calculated to control pump operation for optimal evaporation and overspray control.
Elevated side slopes or adequate wind fences are preferred to contain over spray. (This system uses 12 to 14 vertical foot walls sloped at an average of 2:1 comprised of day soil covered in a waterproof/impermeable liner.) Contamination and leak prevention
An under drain collection system and/or a double lined sump with interstitial monitoring can be installed to detect any leaks in the liner before ground water contamination occurs as well as a pump out point for remediation efforts.
High fluid level shut down. This prevents any overflow of the wastewater containment in the event the return to a (an) lined or unlined pit(s), tank(s), storage vessel(s), other similar or like adequate containment was or became plugged or blocked. This can be accomplished by outfitting a float type switch, transducers, or any other measuring device to pump controls.
Low pressure shut down. This feature is placed inline within the pressure side of the pump(s). If a low pressure is detected, the pump(s) would auto shut down. This prevents wastewater spillage if a pressure line were to rupture or fail.
In order to control and limit precipitation from rainfall or snow melt from entering waste water containment, a storm water control valve can be installed to allow storm water to be directed to an alternative holding area or to storm drains. This valve would remain dosed while the system is in operation. This prevents unwanted fresh water from entering the containment of waste water.

### PUMP PROTECTION

Low fluid level fluid shut down. This prevents pump(s) from running dry in the event the waste water containment in a lined or unlined pit(s), tank(s), storage vessel(s), other similar or like adequate containment gets too low to continue waste water pumping. This can be accomplished by outfitting a float type switch, transducers, or any other electronic measuring device to signal pump controls.

### REFERENCE NUMERALS

10 Non permeable ultra violet resistant liner

12 Anchor ditch

14 Earthen fill material

16 Motor and pump assembly

18 Concrete slab base

20 Reservoir

22 Male cam lock style fitting- pump inlet

24 Suction net hose

26 Female cam lock style fitting-pump suction inlet

28 O-ring gasket

30 Suction inlet screen

32 Male cam lock style fitting inlet screen

34 Female cam lock style fitting-inlet screen

36 O-ring gasket

38 Pump discharge elbow

40 Male cam lock style fitting pump discharge

42 Female cam lock style fitting-discharge header

44 Discharge screen

46 Discharge header

48 Mister head assembly

50 Pipe saddle clamp lower body

52 Pipe saddle clamp Upper body

54 O-ring

56 Primary reducer bushing

58 Secondary reducer bushing

60 Collar

62. Orifice

64 Bolt

66 Nut

68 Nozzle body

70 Misting nozzle

72 Discharge reducer pipe

74 Liquid waste water

76 Atomized water droplets

78 Pipe end cap

80 Weld

82 Earthen side slope

86 Grade plane

### BRIEF DESCRIPTION OF THE DRAWINGS

The following drawings are only typical embodiments of the invention and therefore not to be considered limiting of its scope.

FIG. 1 is an illustrated right side view of the first embodiment of the waste water evaporation apparatus.

FIG. 2 is an illustrated right side enlarged perspective view of the suction hose for the suction inlet of the pump.

FIG. 3 is an illustrated right side enlarged perspective view of the suction screen and suction hose.

FIG. 4 is an illustrated right side enlarged perspective view of the discharge screen and discharge header.

FIG. 5 is an illustrated enlarged right side perspective view of a mister head assembly showing internal components in dotted phantom lines.

FIG. 6 is an illustrated right side elevated perspective view of the waste water evaporation apparatus.

### DESCRIPTION OF THE EMBODIMENT

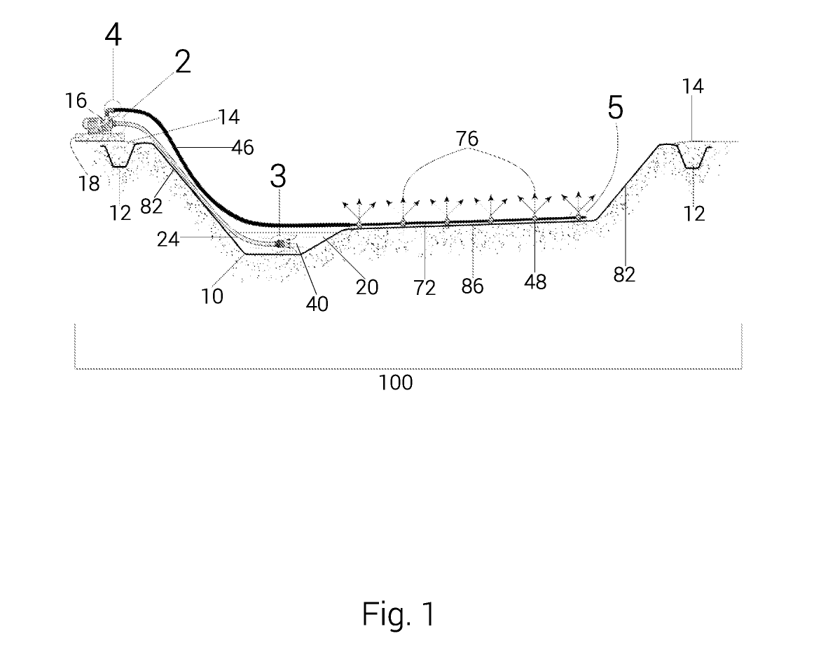

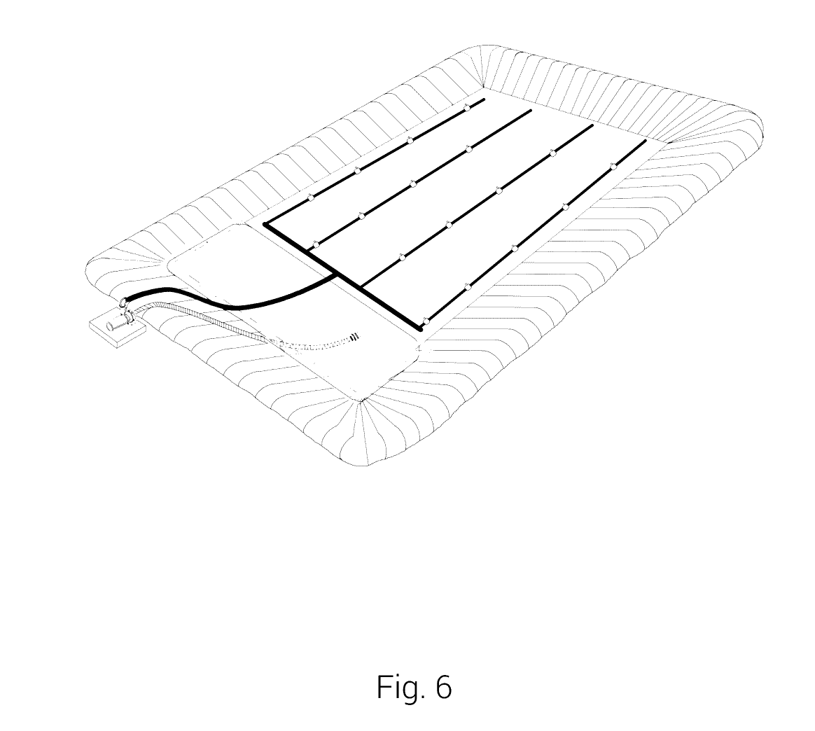

The mode for carrying out the invention is presented in terms of its preferred embodiment, depicted within FIG. 1. through FIG. 6.

Referring first to FIG. 1, the present disclosure describes the waste water evaporation system 100. The waste water evaporation system 100 comprises largely of a pit including a fluid reservoir 20, motor and bump assembly 16, suction inlet hose(s) 24, at east one discharge header pipe 46, at least one discharge reducer pipe 72, and at least one mister head assembly 48.

The majority of the waste water evaporation system 100 is contained in a pit in such a fashion that surrounding side slopes 82 reduce the presence of undesirable weather such as breeze and wind. Fluid reservoir 20, side slopes 82, and grade plane 86, are generally lined with a non permeable ultra violet light resistant liner 10.

The non permeable ultra violet light resistant liner 10 is secured by means of an anchor ditch 12 continuing the radius at the upper most portions or the side slopes of the pit. Anchor ditch 12 is covered with earthen fill material 14. Mister head assemblies 48 reside on a grade plane 86 that is graded such so that any un-evaporated liquid waste water 74 will gravitationally return to reservoir 20.

Motor and pump assembly 16 may be anchored to a concrete slab base 18 placed on suitably stable graded earthen fill material 14 and placed within a proximity suitable to operate effectively and efficiently to provide liquid waste water 74 from fluid reservoir 20 to mist head assemblies 48.

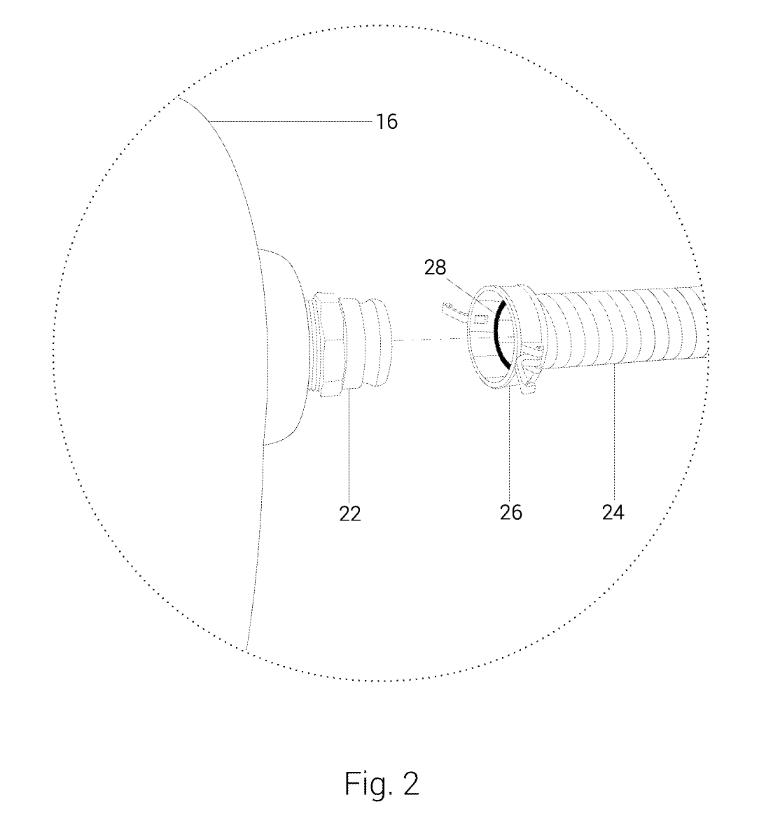

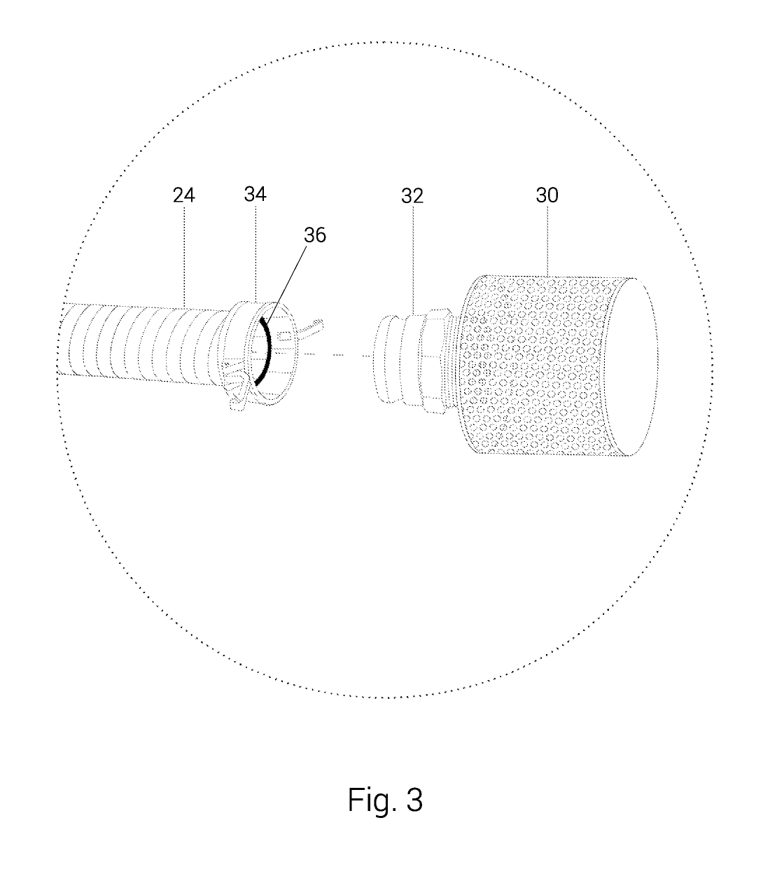

Suction hose 24 preferably being constructed of a suitable collapse resistant hose couples to motor and pump assembly 16 on the suction net of pump and motor assembly 16 as it is illustrated in FIG. 2. Suction hose 24 couples to inlet screen 30 at the opposing end of motor and pump assembly 16 as it is illustrated in FIG. 3.

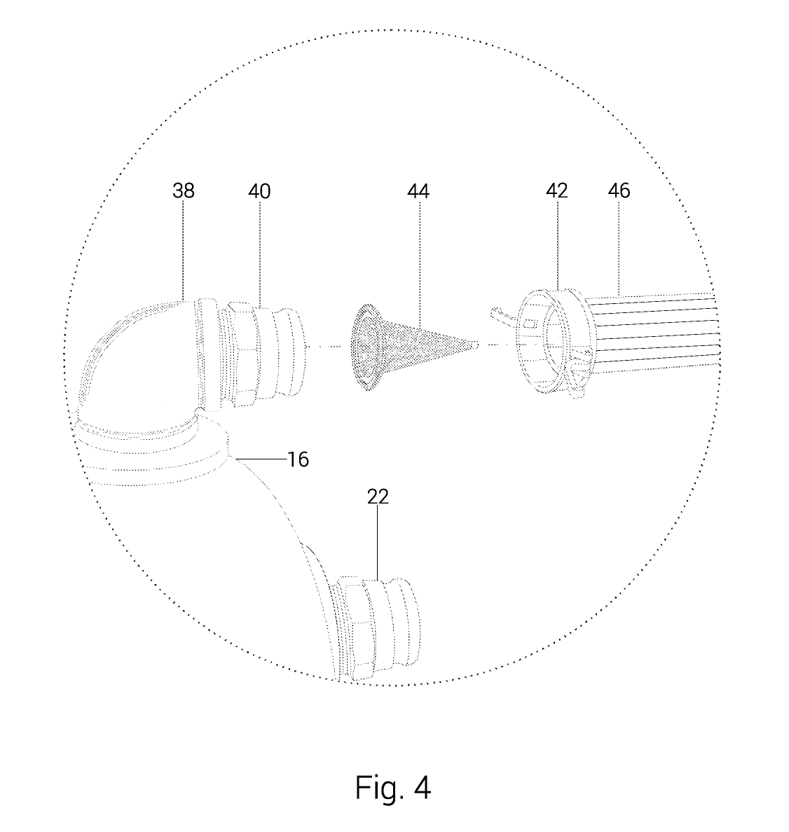

Discharge header 46 preferably being constructed of high density polyethylene (also referred to as HDPE) is coupled to motor and pump assembly 16 at pump and motor assembly discharge outlet as it is illustrated in FIG. 4. Discharge header 46 is affixed by means of welding reducer discharge pipes 72 to discharge header 46 on the opposing end of motor and pump assembly 16.

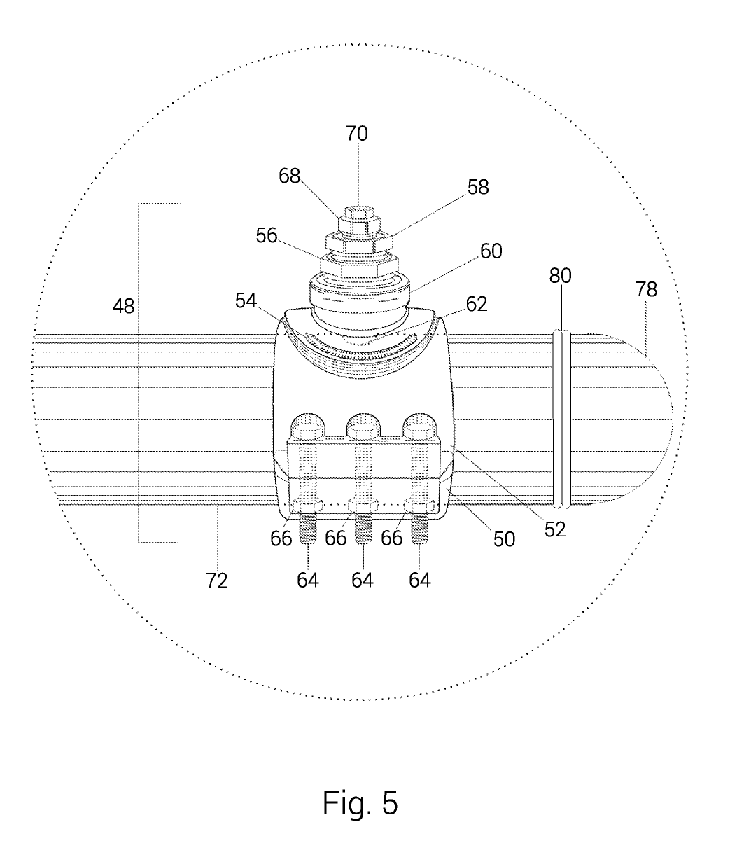

One or more mister head assemblies 48 are fastened to reducer discharge pipes 72 as it is illustrated in FIG. 5 in such a configuration that atomized water droplets 76 when discharged from the misting nozzle 70 do not directly intersect with one another.

Referring to FIG. 2, an illustrated right side enlarged perspective view of the suction hose for the suction inlet of the pump. The male cam lock style fitting 22 is affixed to the suction inlet side of the motor and pump assembly 16. Female cam lock style fitting 26 is affixed to the end of suction inlet hose 24. Suction inlet hose 24 is coupled to motor and pump assembly 16 inlet by coupling male cam lock style fitting 22 and female cam lock style fitting, 26 including O-ring gasket 28 between male cam lock style fitting, 22 and female cam lock style fitting 26. The cam lock style fittings allow for easy disassembly for cleaning and maintenance.

Referring to FIG. 3, an illustrated right side enlarged perspective view of the suction screen and suction inlet hose 24. The male cam lock style fitting 20 is attached to the open end of suction inlet screen 30. On the opposing end of motor and pump assembly 16 of the suction inlet hose 24 female cam lock style fitting 34 is affixed to the end of suction inlet hose 24. Suction inlet screen 30 is affixed to suction inlet hose 24 by coupling male cam lock style fitting 20 and female cam lock style fitting 34 including o-ring gasket 36 between male cam lock style fitting 20 and female cam lock style fitting 34.

Referring to FIG. 4, an illustrated right side enlarged perspective view of the discharge screen and discharge header. The pump discharge elbow 38 is attached to the discharge side of motor and pump assembly 16. Male cam lock style fitting 40 is attached to the opposing end of the motor and pump assembly 16 on the pump discharge elbow 38. Female cam lock style fitting 42 is affixed to discharge header 46. Discharge header 46 is affixed to motor and pump assembly 16 by coupling male cam lock style fitting 40 to female cam lock style fitting 42 including discharge screen 44 between male cam lock style fitting 40 to female cam lock style fitting 42.

Referring to FIG. 5, an illustrated enlarged right side perspective view of a mister head assembly showing internal components in dotted hidden lines. FIG. 5 illustrates mister head assembly 48 as a sum of references 50, 52, 54, 56, 58, 60, 62, 64, 66, 68, and 70. O-ring 54 is installed in the underside of pipe saddle comp upper body 52 around the threaded opening prior to assembly of pipe saddle damp upper body 52 and pipe saddle damp lower body 50. Pipe saddle damp upper body 52 and pipe saddle clamp lower body 50 encapsulate the discharge reducer pipe 72 center of pre drilled orifice 62 at the top radius of the discharge reducer pipe 72 at the desired location of mister head assembly 48. One or more nuts 66 and bolts 64 secure saddle clamp upper body 29 to saddle damp lower body 28 around discharge reducer pipe 72. Pipe end cap 78 is welded 43 to discharge reducer pipe 72 at the opposing end of motor and pump assembly 16.

Collar 60 is placed around the threaded orifice of saddle damp upper body 29. Primary reducer bushing 56 is inserted and threaded into saddle damp upper body 29. Secondary reducer bushing 58 is inserted and threaded into primary reducer bushing 56.

Nozzle body 68 is inserted and threaded into secondary reducer bushing 58. Nozzle body 68 possesses an orifice of adequate size to accomplish pressure gain as well as have volume discharge great enough achieve atomization of waste water delivered from motor and pump assembly 16. Misting nozzle 70 is inserted into nozzle body 68. Misting nozzle 70 possesses an orifice of adequate size to accomplish pressure gain as well as have volume discharge great enough achieve atomization of waste water delivered from motor and pump assembly 16.

Referring to FIG. 6, an illustrated right side elevated perspective view of the waste water evaporation apparatus. This gives a dearer picture of a waste water evaporation system.

What is claimed is:

1. A waste water evaporation system comprising:
A vessel adequate to contain wastewater;
pump(s) for pressurizing wastewater;
of a plurality of misting nozzles to introduce atomized waste water into normal atmospheric conditions;
a network of piping for delivering wastewater to misting nozzles;

2. Said vessel in claim 1 wherein adequate to contain wastewater staged for evaporation;
or return of un-evaporated wastewater to containment;

3. Said plurality of misting nozzles wherein claim 1 arranged such to not interfere with adjacent nozzles or spray patterns;
creates a finely atomized mist of pressurized waste water into the air;

4. Said pumps of evaporation system in claim 1 wherein pressurizes wastewater via networked grid pattern of piping.
